(19) United States
(12) Patent Application Publication
(10) Pub. No.: US 2024/0053543 A1
(43) Pub. Date: Feb. 15, 2024

(54) HIGH COUPLING EFFICIENCY BLAZED WAVEGUIDE GRATING COUPLER

(71) Applicant: The Chinese University of Hong Kong, Shatin, N.T. (CN)

(72) Inventors: Hon Ki TSANG, Ma On Shan, N.T. (CN); Xuetong ZHOU, Xingtai City (CN)

(21) Appl. No.: 18/278,594

(22) PCT Filed: Feb. 24, 2022
(86) PCT No.: PCT/CN2022/077539

§ 371 Date: Aug. 23, 2023

Related U.S. Application Data
(60) Provisional application No. 63/153,224, filed on Feb. 24, 2021.

(51) Int. Cl. G02B 6/34

(52) U.S. Cl. CPC G02B 6/34

(57) ABSTRACT

A system for optical communication comprises a waveguide (110) and an optical coupler (100). The waveguide (110) is provided with a core of higher refractive index material disposed on a substrate (204). The optical coupler (100) is used to couple light between an integrated optical waveguide (110) and an optical fiber (120) with high coupling efficiency. The optical coupler (100) comprises a first grating (104) having a first set of ridges (224) separated by a first set of trenches (220) and a second grating (108) having a second set of ridges (234) separated by a second set of trenches (230). The first grating (104) is formed in the core of the waveguide (110). The second set of ridges (234) are offset from the first set of ridges (224). A method for fabricating the optical coupler (100) is also provided.

### CROSS-REFERENCES TO RELATED APPLICATIONS

This application claims priority to U.S. Provisional Application No. 63/153,224, filed on Feb. 24, 2022, the disclosure of which is incorporated by reference in its entirety for all purposes.

### TECHNICAL FIELD

Embodiments of the present disclosure relate to the technical fields of communications.

### BACKGROUND

Optical communication uses light to convey information. Data centers and communication across the Internet rely heavily on optical-fiber communication. A coupler (e.g., a grating coupler) can be used to couple light from waveguides to an optical fiber.

For an angled grating coupler, in 2007, Frederik Van Laere et al. demonstrated a high coupling efficiency grating coupler by adding a gold bottom mirror to the structure. F. Van Laere et al., “Compact and Highly Efficient Grating Couplers Between Optical Fiber and anophotonic Waveguides,” Journal of Lightwave Technology, vol. 25, no. 1, pp. 151-156, 2007, doi: 10.1109/jlt.2006.888164. They realized −1.42 dB theoretical and −1.61 dB experiment coupling efficiency, and the footprint is around 10×10 μm, with minimum feature size of 305 nm. The coupling angle of their device is 10 degrees.

In 2010, Xia Chen et al. demonstrated the high coupling efficiency grating coupler by using apodized waveguide grating. X. Chen, C. Li, C. K. Y. Fung, S. M. G. Lo, and H. K. Tsang, “Apodized Waveguide Grating Couplers for Efficient Coupling to Optical Fibers,” IEEE Photonics Technology Letters, vol. 22, no. 15, pp. 1156-1158, 2010, doi: 10.1109/lpt.2010.2051220. They realize a coupling efficiency of −1.2 dB in experiment, and the footprint is 520×10.4 μm, with minimum feature size of 44 nm. The coupling angle of their device is 10 degrees.

In 2010, D. Vermeulen et al. demonstrated the high coupling efficiency grating coupler by adding a polysilicon overlay. D. Vermeulen et al., “High-efficiency fiber-to-chip grating couplers realized using an advanced CMOS compatible Silicon-On-Insulator platform,” (in English), Optics Express, vol. 18, no. 17, pp. 18278-18283, Aug. 16, 2010, doi: 10.1364/0e.18.018278. The polysilicon overlay served only to increase the thickness of grating teeth for upward diffracted light to have constructive interference. They realized −1.6 dB experiment coupling efficiency. The footprint is around 300×15 μm with minimum feature size of 240 nm, and the coupling angle of their device is 13 degrees.

In 2015, Daniel Benedikovic et al. demonstrated the high coupling efficiency grating coupler by using interleaved trenches and subwavelength index-matching structure. D. Benedikovic et al., “High-directionality fiber-chip grating coupler with interleaved trenches and subwavelength index-matching structure,” Opt Lett, vol. 40, no. 18, pp. 4190-3, Sep. 15 2015, doi: 10.1364/0L.40.004190. They realized −1.1 dB theoretical and −1.3 dB experiment coupling efficiency with minimum feature size of 100 nm. The grating is angle coupled.

In 2018, Jason C. Mak et al. demonstrated the high coupling efficiency grating coupler by combining silicon nitride-on-silicon bi-layer grating couplers with inverse design method. J. C. C. Mak, Q. Wilmar, S. Olivier, S. Menezo, and J. K. S. Poon, “Silicon nitride-on-silicon bi-layer grating couplers designed by a global optimization method,” Opt Express, vol. 26, no. 10, pp. 13656-13665, May 14, 2018, doi: 10.1364/0E.26.013656. They realized −1.5 dB theoretical and −2.2 dB experiment coupling efficiency with minimum feature size of 255 nm. The coupling angle of their device is 29 degrees.

For orthogonal coupler, in 2007, Gunther Roelkens et al. demonstrated the perfectly vertical coupled grating coupler by using of additional slits. G. Roelkens, D. Van Thourhout, and R. Baets, “High efficiency grating coupler between silicon-on-insulator waveguides and perfectly vertical optical fibers,” Opt. Lett., vol. 32, no. 11, pp. 1495-1497, Jun. 1, 2007, doi: Doi 10.1364/01.32.001495. They realized a simulation coupling efficiency of 50% with minimum feature size of 160 nm.

In 2008, Xia Chen et al. demonstrated the perfectly vertical coupled grating coupler by using chirped grating structure. X. Chen, L. Chao, and Hon Ki Tsang, “Fabrication-Tolerant Waveguide Chirped Grating Coupler for Coupling to a Perfectly Vertical Optical Fiber,” IEEE Photonics Technology Letters, vol. 20, no. 23, pp. 1914-1916, 2008, doi: 10.1 109/lpt.2008.2004 715. They realized simulation coupling efficiency of 42% and experiment result of 34%. The minimum feature size is 244 nm.

In 2013, John Covey et al demonstrated the perfectly vertical coupled grating coupler by using of multiple slot waveguides structure. J. Covey and R. T. Chen, “Efficient perfectly vertical fiber-to-chip grating coupler for silicon horizontal multiple slot waveguides,” Opt Express, vol. 21, no. 9, pp. 10886-96, May 6, 2013, doi: 10.1364/0E.21.010886. They realize a simulation coupling efficiency of 68% and experiment result of 60%. The footprint is around 500×12 μm with minimum feature size smaller than 40 nm.

In 2017, Siya Wang et al. demonstrated the perfectly vertical coupled grating coupler by using of tilted silicon membrane. S. Wang et al., “Compact high-efficiency perfectly-vertical grating coupler on silicon at 0-band,” Opt Express, vol. 25, no. 18, pp. 22032-22037, Sep. 4, 2017, doi: 10.1364/0E.25.022032. They realized a simulation coupling efficiency of 66.2% and experiment result of 57%. The footprint is around 60×10 μm with minimum feature size of 145 nm.

In 2017, Tatsuhiko Watanabe et al. demonstrated the perfectly vertical coupled grating coupler by using of blazed anti-back-reflection structures. T. Watanabe, M. Ayala, U. Koch, Y. Fedoryshyn, and J. Leuthold, “Perpendicular Grating Coupler Based on a Blazed Antiback-Reflection Structure,” Journal of Lightwave Technology, vol. 35, no. 21, pp. 4663-4669, 2017, doi: 10.1109/jlt.2017.2755673. They realized a simulation coupling efficiency of 87% and experiment result of 71%. The footprint is around 200×14 μm with minimum feature size smaller than 40 nm.

In 2018, Yeyu Tong et al. demonstrated the perfectly vertical coupled grating coupler by using genetic method. Y. Tong, W. Zhou, and H. K. Tsang, “Efficient perfectly vertical grating coupler for multi-core fibers fabricated with 193 nm DUV lithography,” Opt Lett, vol. 43, no. 23, pp. 5709-5712, Dec. 1, 2018, doi: 10.1364/0L.43.005709. They realize a simulation coupling efficiency of 62% and experiment result of 54%. The footprint is around 30×24 μm with minimum feature size of 206 nm.

In 2019, Zanyun Zhang et al. demonstrated the perfectly vertical coupled grating coupler by using bidirectional subwavelength structure. Z. Zhang et al., “High-efficiency apodized bidirectional grating coupler for perfectly vertical coupling,” Opt Lett, vol. 44, no. 20, pp. 5081-5084, Oct. 15, 2019, doi: 10.1364/0L.44.005081. They realize a simulation coupling efficiency of 72% and experiment result of 66%. The footprint is around 800×12 μm with minimum feature size of 100 nm.

With a rapid growth of data traffic, there exists a need for improved optical communication systems and methods. Grating couplers that couple broadband light from a semiconductor waveguide to an optical fiber can help reduce cost of optical interconnects by enabling wafer scale testing and by reducing the precision of mechanical alignment between the optical fiber and the semiconductor optical chip (e.g., when compared to the use of edge couplers into small core diameter fibers).

### SUMMARY

This application relates to optical communication, and, without limitation, to a grating coupler for optical communication. In some configurations, a second grating is formed on a first grating to form a coupler between a semiconductor and an optical fiber, wherein ridges of the second grating are offset from ridges of the first grating. By having offset gratings, coupling efficiency can be increased while using processes available in standard foundries. For example, an optimized pattern is formed in a polysilicon overlay on a single-crystal silicon grating.

In some embodiments, a system for optical communication comprises a substrate; a first set of ridges, wherein the first set of ridges are defined by a first period; a second set of ridges, wherein: the second set of ridges are disposed on the first set of ridges, such that the first set of ridges are between the substrate and the second set of ridges; the second set of ridges are defined by a second period; and the second grating period is offset from the first grating period.

In some embodiments, a system for optical communication comprises a waveguide having a core disposed on a substrate, wherein the core is configured to guide light along a first propagation direction. The coupler comprises a first grating formed in the core, wherein the first grating comprises a first set of ridges separated by a first set of trenches; and a second grating, wherein: the second grating comprises a second set of ridges separated by a second set of trenches; the second set of ridges partially overlap the first set of ridges; the second set of ridges partially overlap the first set of trenches; the coupler is configured to couple light out of the waveguide along a second propagation direction; and the second propagation direction is not parallel with the first propagation direction.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 illustrates a simplified perspective view of an embodiment of an output coupler.

FIG. 2 illustrates a simplified cross section view of an embodiment of an output coupler having a shifted overlay.

FIG. 3 illustrates a simplified cross section view of an embodiment various vertical structures.

FIG. 4 illustrates a chart of effective index for an embodiment of various vertical structures.

FIG. 5 illustrates a chart of trench widths of an embodiment of a first grating.

FIG. 6 illustrates a chart of ridge widths of the embodiment of the first grating.

FIG. 7 illustrates a chart of trench widths of an embodiment of a second grating.

FIG. 8 illustrates a chart of ridge widths of the embodiment of the second grating.

FIG. 9 illustrates a chart of simulated coupling efficiency of an embodiment of an output coupler for orthogonal output coupling into a single-mode fiber.

FIG. 10 illustrates a chart of simulated coupling efficiency of an embodiment of an output coupler for angled output coupling into a single-mode fiber.

FIG. 11 illustrates a chart of simulated coupling efficiency of an embodiment of an output coupler for orthogonal output coupling into a few-mode fiber, TE0 mode.

FIG. 12 illustrates a chart of simulated coupling efficiency of an embodiment of an output coupler for orthogonal output coupling into a few-mode fiber, TE1 mode.

FIG. 13 illustrates a chart of simulated coupling efficiency of an embodiment of an output coupler for orthogonal output coupling into a multimode fiber, TE0 mode.

FIG. 14 illustrates a chart of simulated coupling efficiency of an embodiment of an output coupler for orthogonal output coupling into a multimode fiber, TE1 mode.

FIG. 15 illustrates a chart of simulated coupling efficiency of an embodiment of an output coupler for orthogonal output coupling into a multimode fiber, TE3 mode.

FIG. 16 illustrates a flowchart of an embodiment of a method for forming an optical coupler.

FIG. 17 illustrates a chart of experimental orthogonal coupling efficiency of an embodiment of an optical coupler.

FIG. 18 illustrates a chart of simulated TE mode coupling efficiency for a dual-polarization coupler.

FIG. 19 illustrates a chart of simulated TM mode coupling efficiency for the dual-polarization coupler.

FIG. 20 illustrates a chart of experimental TE mode coupling efficiency for the dual-polarization coupler.

FIG. 21 illustrates a chart of experimental TM mode coupling efficiency for the dual-polarization coupler.

FIG. 22 illustrates a chart of simulated coupling efficiency for an embodiment of a dual-wavelength coupler.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF EMBODIMENTS

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

### I. Introduction

Today most of the internet traffic eventually gets routed to at least one of the many data centers that are connected to the internet, and the cumulative traffic in data centers (including traffic which is not routed outside the data center) is typically several times large than the external internet traffic. Hyper-scale data centers are handling increasing volumes of data traffic because the exponential growth of internet data traffic continues unabated, with a doubling in total traffic approximately every 18 months. It is already widely recognized that more efficient and lower power consumption wavelength multiplexing devices will be used to meet future demand for data communications.

In some configurations, more efficient and/or lower power consumption wavelength multiplexing devices using alignment tolerant waveguide grating couplers in optical transceivers is disclosed. Higher coupling efficiency of both vertical and angle coupled grating couplers for single mode fiber, few mode fiber, multi-mode fibers (e.g., OM2, OM3, OM4, OM5, etc.) enable lower power consumption and also lower the packaging cost for easier alignment and avoiding the angle-polishing of the perfectly vertical grating coupler. High coupling efficiency perfectly vertical coupled (e.g., out-of-plane; orthogonal) grating coupler can also enable deployment of multi-core fibers to realize space-division-multiplexing for lower angle dependent and/or spatial-channel-dependent loss of perfectly vertical coupled grating. In some embodiments, current waveguide grating coupler technologies in the foundry under the constraint of 193 nm deep-ultraviolet lithography have lower coupling efficiency. A higher efficiency grating coupler will enable scaling to more efficient and lower power consumption wavelength multiplexing channels. The technology of high coupling efficiency and lower power consumption wavelength multiplexing interconnects could be used 5G backhaul networks in future wireless base stations.

Some embodiments disclosed serve as a high coupling efficiency optical interface between a photonic integrated circuit and an optical fiber (e.g., including single mode fiber, few mode fiber, or multimode fiber) for use in a mode multiplexed high capacity optical communication system. Applications can include optical communication in data centers (e.g., for power consumption to meet requirements of high communications capacity in hyper-scale data centers). Utilization of an efficient coupling strategy in mode multiplexing is one approach to meet the power budget. Photonic integrated circuits can be deployed in large quantities for optical fiber based optical interconnects in hyper-scale data centers. There is a need for high coupling efficiency grating couplers to enable future lower power consumption, low cost, and/or higher optical bandwidth wavelength multiplexing transceivers. Some embodiments may be used for building optical transceivers capable of terabit/s data transmission involving the use of more wavelength channels with lower power consumption.

Coupling efficiency of waveguide grating couplers can be increased by using an apodized waveguide grating coupler, bottom metal mirror, L-shaped grating, an additional layer of polysilicon, interleaved trenches, and silicon nitride-on-silicon (e.g., with an inverse design). In certain configurations, a high coupling efficiency grating coupler is realized using a different method, in addition to or in lieu of, the techniques just listed. To achieve high coupling efficiency, an optimized pattern of a polysilicon overlay, patterned differently from the silicon grating structure over which it is deposited, is used. The silicon grating has a first set of teeth (e.g., ridges), and the polysilicon overlay has a second set of teeth, the positions of the teeth of the polysilicon overlay are shifted with respect to the teeth of the silicon gratings and are patterned independently (e.g., unlike the approach of D. Vermeulen et al. in paragraph [0006], where teeth of a polysilicon overlay are aligned with teeth of a silicon grating). Carefully optimizing of widths of the teeth and widths of trenches of the polysilicon overlay and the silicon grating can improve upward light constructive interference and downwards light destructive interference of an optical coupler. Thus directionality of the optical coupler is improved. Shift between the polysilicon overlay layer and the silicon grating is not limited by a minimum feature size (e.g., not constrained by 193 nm deep-ultraviolet lithography). Rather, the shift is limited by photolithography registration accuracy, and the shift can further improve coupling efficiency by having better mode-matching between the diffracted light and the fiber mode (e.g., by using grating apodization).

Some configuration realize higher coupling efficiency compared with using 193 nm deep-ultraviolet lithography. By introducing a shift of the polysilicon overlay with respect to the silicon grating, an effective index of a subwavelength structure in the vertical direction is gradually increased, and, with carefully design, a blazing of the diffraction grating can be effectively realized (e.g., to improve the coupling efficiency). For example, a numerical optimization of periods and slit widths and shift of the polysilicon overlay layer to the silicon grating can be performed to engineer a diffracted mode to match a mode profile of an optical fiber.

Numerical optimization has been carried out using a subwavelength structure with minimum feature size above 170 nm (e.g., to satisfy the design rules for fabrication at a commercial foundry). An example of the optimized structure is provided below. Simulation results show that a record high coupling efficiency of −0.91 dB and −0.74 dB for perfectly vertical and angled off vertical coupling, respectively. Thus, high coupling efficiency can be achieved under the constraint of 193 nm deep-ultraviolet lithography for both vertical and angle coupled grating. In some embodiments, the coupling efficiency of a single mode waveguide grating coupler can be increased from about −2.47 dB (for existing couplers manufactured in commercial foundries) to optical coupling efficiencies of −0.74 dB. For a few-mode fiber, the coupling efficiency can be −1 dB and −1.7 dB for TE0 and TE1 modes, respectively. For multimode fibers such as OM2, OM3, OM4, or OM5 fiber, the coupling efficiency can be −1.95 dB, −1.97 dB, and −2.35 dB for the TE0, TE1, and TE3 modes, respectively.

### II. Sample Approach

Coupling light with a high efficiency, using an optical coupler, can be beneficial in optical transceivers used in data centers with optical fiber interconnects. Some configurations are compatible with mode division multiplexing and use with multimode optical fibers for efficient mode division multiplexing. An optical coupler with high efficiency can be used in high capacity silicon photonic transceiver and is suitable for both wavelength and mode division multiplexing. The embodiment below of an optical coupler is designed for high-efficiency coupling under the fabrication constraint of using 193 nm deep-ultraviolet lithography with a minimum feature size of 170 nm.

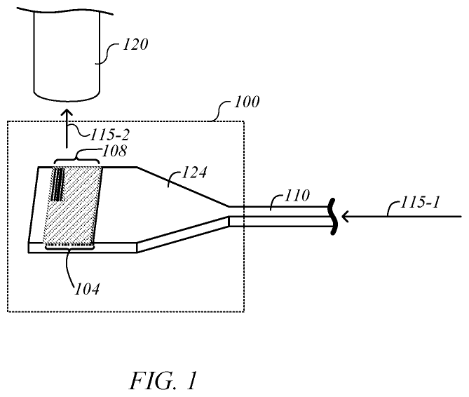

Referring first to FIG. 1, a simplified perspective view of an embodiment of an output coupler 100 is shown. The output coupler comprises a first grating 104 and a second grating 108. A waveguide 110 is configured to guide light along a first propagation direction 115-1. For example, the waveguide 110 comprises a core and a cladding that confine light in one or more transverse directions, so that light propagates in a longitudinal direction of the waveguide 110. The core is made of a higher refractive index (e.g., as compared to the cladding) and the cladding is made of a lower-refractive index (e.g., as compared to the core). In some embodiments the core is a semiconductor or dielectric (e.g., silicon, InP, GaAs, silicon nitride, or lithium niobate). In some embodiments, the core is a single-crystal structure (e.g., single crystal silicon, InP, GaAs, etc.). The core is sometimes referred to as a device layer. For example, the core is part of a device layer of a silicon-on-insulator (SOI) wafer or of a lithium niobate-on-insulator (LNOI). The cladding has a lower refractive index than the core. For example, the cladding can be an insulating layer such as silicon dioxide and/or air.

Light propagating in the first propagation direction 115-1 is directed to the output coupler 100. The output coupler 100 is configured to couple light out of the waveguide 110 along a second propagation direction 115-2. The second propagation direction 115-2 is not parallel to the first propagation direction 115-1. Light traveling in the second propagation direction 115-2 is coupled into an optical fiber 120.

The first grating 104 is formed in the core of the waveguide 110. The second grating 108 is formed as an overlay deposited on the semiconductor core. In some embodiments, the overlay is a non-single-crystal layer. In some embodiments the overlay layer is a semiconductor or a dielectric (e.g., amorphous silicon that is annealed to become polycrystalline silicon). Ridges of the second grating are formed in the overlay layer. The second grating 108 is shifted with respect to the first grating 104. The output coupler 100 comprises a taper 124 to expand light before light reaches the first grating 104 and the second grating 108.

FIG. 2 shows a simplified cross section view of an embodiment of the output coupler 100 having a shifted overlay. The output coupler 100 comprises the first grating 104 and the second grating 108. The cross section is in a plane that is parallel to the first propagation direction 115-1, and includes a component of the out-coupling direction (i.e., the second propagation direction 115-2).

The first grating 104 is formed by etching the core. The core is disposed on a substrate. The For example, a silicon-on-insulator (SOI) wafer is used. The SOI wafer comprises a substrate 204, a device layer 208, and an insulating layer 212 between the substrate 204 and the device layer 208. A first set of trenches 220 are etched in the device layer to form a first set of ridges 224. In some embodiments, the first set of trenches 220 are etched to the same depth. The first set of trenches 220 are filled (e.g., with an insulating material; with silicon dioxide) with a material having a lower refractive index than the device layer 208.

An overlay layer (e.g., polycrystalline silicon) is deposited on the device layer 208, and a second set of trenches 230 are etched in the deposited material to form a second set of ridges 234. The ridges of the first grating are between the ridges of the second grating and a substrate. The second set of trenches 230 are etched to, but not into, the device layer 208. In some embodiments, the second set of tranches 230 are etched into the device layer. The second set of ridges 234 are shifted compared to the first set of ridges 224 (e.g., the second set of ridges 234 partially overlap the first set of ridges 224 and partially overlap the first set of trenches 220). Widths of trenches and ridges are measured in a direction of the first propagation direction 115-1. Four vertical structures are identified with a line and a circled number.

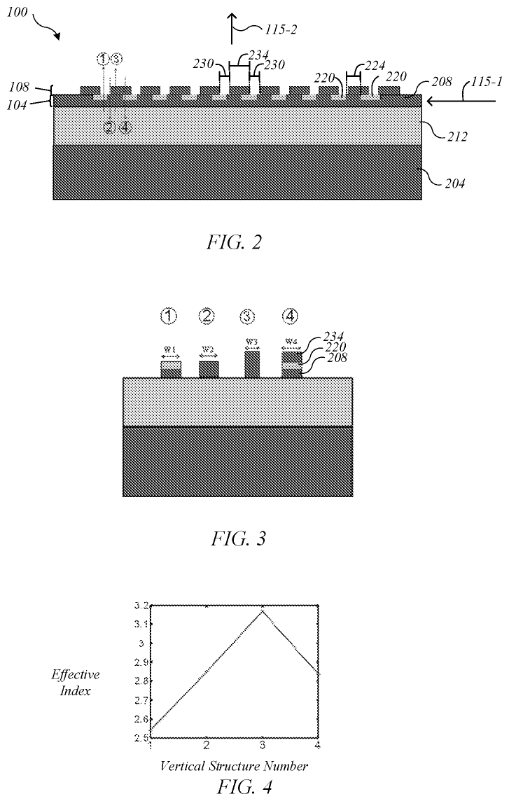

FIG. 3 is a simplified cross section view of an embodiment various vertical structures. A shift of the second grating 108 with respect to the first grating 104, we will produce 4 vertical structures (e.g., subwavelength structures). Widths of these vertical structures are not limited by a minimum feature size within a single layer of the 193 nm deep-ultraviolet lithography, but instead are limited by an accuracy of registration of photolithography of different layers. Registration of photolithography is usually much more precise than the minimum feature size within a layer. Vertical structure 1 has a vertical dimension of the device layer 208 and the first trench 220. Vertical structure 2 has a vertical dimension of the device layer 208 and the first ridge 224. Vertical structure 3 has a vertical dimension of the device layer 208, the first ridge 224, and the second ridge 234. Vertical structure 4 has a vertical dimension of the device layer 208, the first trench 220, and the second ridge 234.

FIG. 4 is a chart of effective index for an embodiment of the various vertical structures. Vertical structure 1 has the lowest index. Vertical structure 2 has the second lowest index. Vertical structure 3 has the highest index. Vertical structure 4 has an index less than vertical structure 3 and/or larger than vertical structure 1.

The second grating 108 is shifted with respect to the first in order to engineer constructive interference for upward diffracted light and destructive interference for downward diffracted light. Combined with the layer shift to produce the output coupler 100 can be used to engineer the effective index profile to realize a blazed grating that can improve coupling efficiency of out of plane waveguide grating couplers, including both perfectly vertical (e.g., orthogonal) and off-vertical angle waveguide grating couplers.

The first grating 104 and the second grating 108 will each diffract the light upwards (e.g., in the direction of the second propagation direction 115-2) and downwards (e.g., in a direction opposite of the second propagation direction 115-2). To enhance a directionality of the output coupler 100, each ridge of the second set of ridges 234 and each trench of the second set of trenches 230 of the second grating 108 is shifted with respect to the first grating 104. By properly engineering the shift in position, the upwards diffracted light of the second grating 108 will have constructive interference with the diffracted light from the first grating 104, while having destructive interference in the downwards direction, thus improving the directionality and the coupling efficiency of the output coupler 100. The shift in position between the first grating 104 and the second grating 108 also enables a gradual change in effective index, which can effectively provide a blazing effect of grating, and thus realize high coupling efficiency for both off-vertical angled and perfectly vertical grating couplers.

### III. Genetic Optimization

In certain embodiments, a numerical optimization of each period and duty cycle of the gratings is performed. The first grating 104 and the second grating 108 each have a non-uniform grating period and/or duty cycle. Ridge widths and trench widths can be designed by using a numerical optimization method, such as genetic optimization, adjoint based optimization, or particle swarm optimization. Numerical optimization is used to design a diffracted mode to match a mode profile of the optical fiber and have destructive interference in the downward direction.

An embodiment of a genetic optimization algorithm includes six steps:
i. Population initialization
ii. Fitness evaluation
iii. Termination criteria
iv. Selection
v. Crossover
vi. Mutation

An optimization loop is fed by a randomly perturbed periodic grating (average period equal to periods calculated by the grating equation under the target central wavelength) in the initialization step, step i. Each population is a vector of a point in the search space. The fitness F is defined as the calculated coupling efficiency across the target wavelength band.

For example, the fitness F includes simulations that cover the wavelength range from 1500 nm to 1600 nm, step ii. In step iii, determination of the termination of iterations according to the criteria that no improvement has been obtained in the most-recent 30 generations. In step iv, selection, populations are kept using the Roulette-Wheel selection method. The step v crossover function is implemented at an 80% probability to intermix the populations with each other. The reproduced populations would experience mutation, step vi, at a probability of 5%, where the structural parameters experience random variations. To possess a robust fabrication performance, the minimum feature size is restricted above the 193 nm DUV lithography for large-volume manufacturing by the commercial silicon photonics foundries, in some embodiments. After the mutation step vi, the process returns to fitness evaluation, step ii.

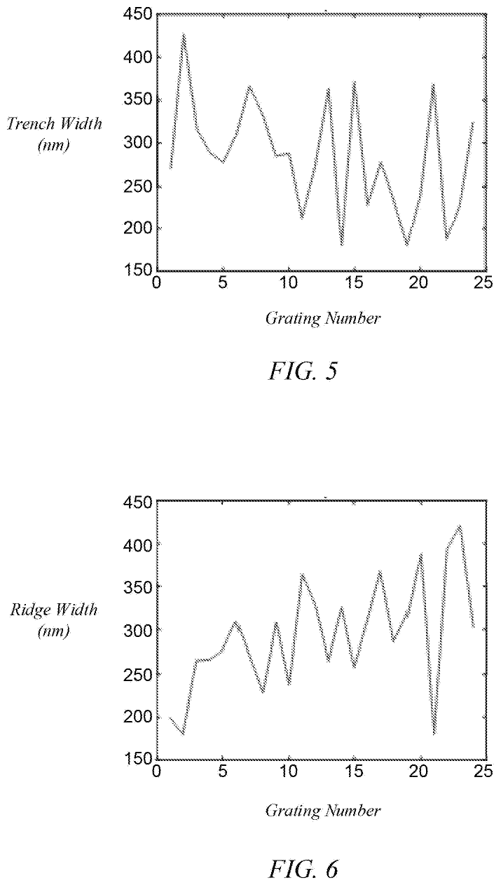

FIGS. 5-8 are results of an embodiment of ridge widths and trench widths for two gratings on top of each other.

FIG. 5 illustrates a chart of trench widths (e.g., etch widths) of an embodiment of a first grating (e.g., the first grating 104 in FIG. 2).

FIG. 6 illustrates a chart of ridge widths of the embodiment of the first grating.

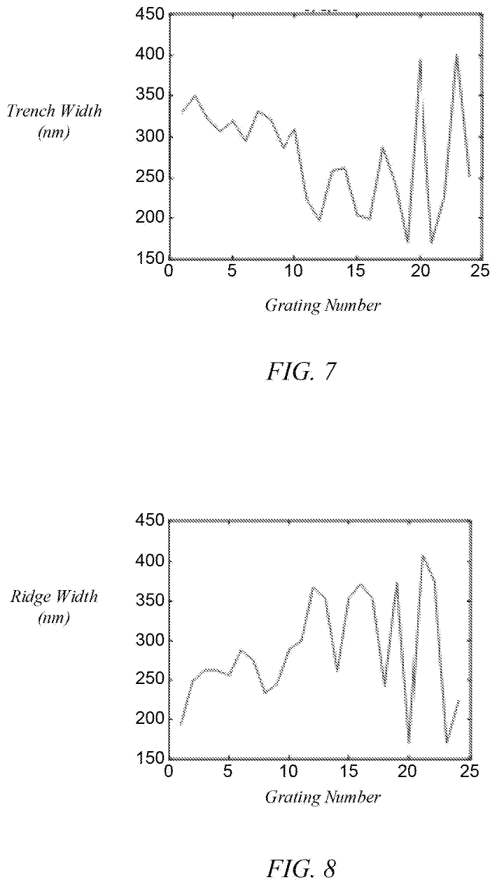

FIG. 7 illustrates a chart of trench widths (e.g., etch widths) of an embodiment of a second grating (e.g., the second grating 108 in FIG. 2).

FIG. 8 illustrates a chart of ridge widths of the embodiment of the second grating. By modifying ridge and trench widths, an apodized-type grating can be formed. For example, strength of the output coupler is gradually increased so that the diffracted profile matches a fiber mode. For example, a first part of the output coupler has smaller coupling strength and gradually increases coupling strength. Coupling strength is based on a difference between an average index from one period to the next. For example, due to a high index contrast between structure 1 and 3, the first part period will have a very low fill factor (0.08) to realize the smaller coupling strength, and a minimum feature size can be below a foundry etching limitation. To realize smaller coupling strength in the first part of the coupler, rather than using lower fill factor, here we introduce subwavelength structure of 2 and 4, which have comparable effective index with subwavelength structure 1, which means that lower the index contrast between the ridge and trench regions of the grating, thus lower coupling strength in the front part of grating is realized without using a lower fill factor (which means very minimum feature size) and realize high coupling efficiency using the feature size above 170 nm. Applicant has found that using described techniques with smaller feature size below 170 nm results in even higher coupling efficiency.

Using the chirped etched widths high coupling efficiency can be realized and the width of the etched region is gradually increased. By having structures 2 and 4 both having an intermediate effective index between structures 1 and 3 (trenches and ridges of a grating), coupling strength of the coupler can be engineered in a wide range with different combinations of the four subwavelength structures 1, 2, 3, and 4 (in FIG. 3). The widths of the four subwavelength structures are not limited by the minimum feature size limitation of the foundry. Using variables widths of the structures 1, 2, 3, and 4 (in FIG. 3), can realize desired coupling strength diffracted light that matches with a Gaussian mode. The desired coupling strength of a grating can be used to determine each duty cycle of the grating coupler, with the determined duty cycle, each period of the grating can be calculated based on the grating equation. Then, modifying structure widths (e.g., by setting widths of etches and ridges) can be used to create the desired coupling strength needed to diffracted light that matches the Gaussian mode. X. Chen, C. Li, C. K. Y. Fung, S. M. G. Lo and H. K. Tsang, “Apodized Waveguide Grating Couplers for Efficient Coupling to Optical Fibers,” in IEEE Photonics Technology Letters, vol. 22, no. 15, pp. 1156-1158, Aug. 1, 2010, provides information about apodized waveguide grating couplers.

The periods, trench widths, and ridge widths in FIGS. 5-8 are non-uniform (e.g., they are variable). For example, a uniform grating has a period, trench widths, and ridge widths that are uniform (e.g., variation less than 1% or 2%). The periods, trench widths, and ridge widths shown in FIGS. 5-8 have variation (e.g., plus or minus) from an average value. In some embodiments the variation from the average value is equal to or greater than 10%, 25%, 30%, and/or 40% and/or equal to or less than 50% or 100% or 200%. For example, trench width in FIG. 5 varies from about 180 nm to 425 nm, with periods varying from an average value up to about 50%.

### IV. Sample Coupling Efficiencies

After running a numerical optimization, each period and duty cycle of the gratings for both the top polysilicon overlay layer and the underlying layer is obtained, and a high coupling efficiency grating coupler composed of optimized polysilicon layer grating is thus built up. 3D FDTD simulations were applied to simulate the coupling efficiency of the output coupler.

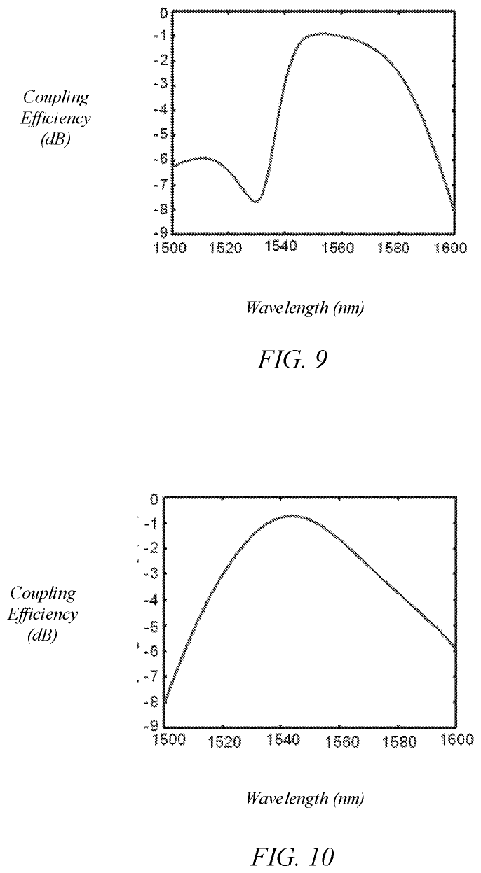

In FIG. 9, a chart of simulated coupling efficiency of an embodiment of an output coupler for orthogonal output coupling into a single-mode fiber is shown. FIG. 9 shows a coupling efficiency of −0.91 dB with 1 dB bandwidth of 34 nm.

Engineering the polysilicon layer blazed grating structure to maximize diffraction off-vertical coupling efficiency is also possible in the optimization procedure. FIG. 10 is a chart of simulated coupling efficiency of an embodiment of an output coupler for angled output coupling into a single-mode fiber. FIG. 10 shows −0.74 dB coupling efficiency with 1 dB bandwidth of 34 nm. Higher coupling efficiency is possible with further optimization of the layer effective index, such as using a subwavelength structure to engineer the effective index of ridges and trenches of both the upper polysilicon overlay layer and the lower underlying grating layer. Both the vertical and angle coupling efficiency results surpass any waveguide grating coupler previously reported under the constraint of 193 nm deep-ultraviolet lithography.

The above design rule of high coupling efficiency grating coupler can also be applied to design high coupling efficiency grating coupler for few-mode fiber (FMF) and multi-mode fiber (MMF), OM2, OM3, OM4, OM5, etc. The results below are from 3D simulations.

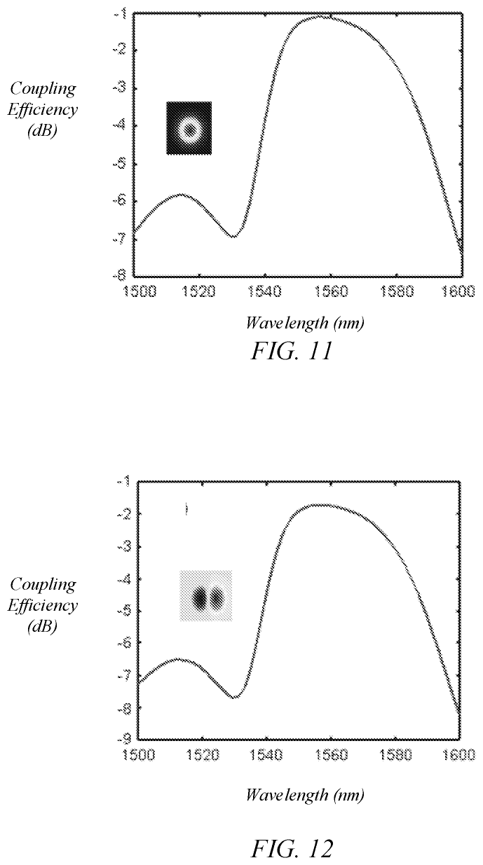

FIG. 11 is a chart of simulated coupling efficiency of an embodiment of an output coupler for orthogonal output coupling into a few-mode fiber, TE0 mode. The coupling efficiency is −1.0 dB with 1 dB bandwidth of 34 nm.

FIG. 12 is a chart of simulated coupling efficiency of an embodiment of an output coupler for orthogonal output coupling into a few-mode fiber, TE1 mode. The coupling efficiency is −1.7 dB with 1 dB bandwidth of 34 nm.

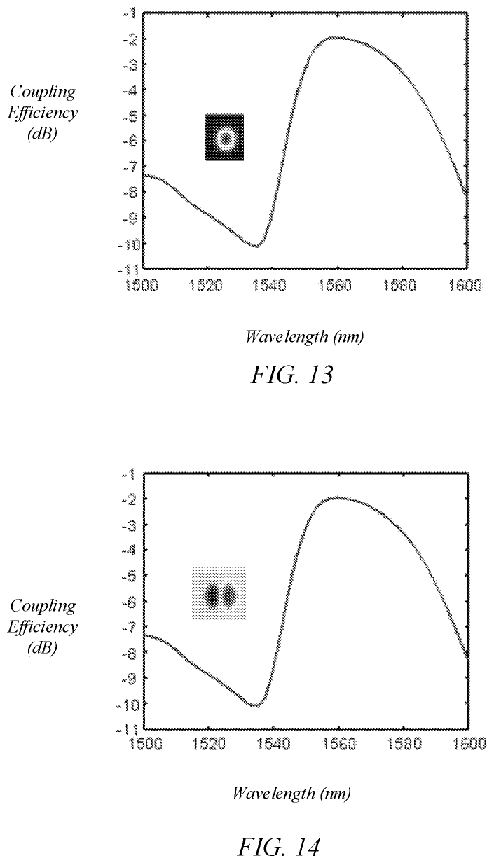

FIG. 13 is a chart of simulated coupling efficiency of an embodiment of an output coupler for orthogonal output coupling into a multimode fiber (e.g., OM4), TE0 mode. The coupling efficiency is −1.95 dB with 1 dB bandwidth of 28 nm.

FIG. 14 is a chart of simulated coupling efficiency of an embodiment of an output coupler for orthogonal output coupling into a multimode fiber (e.g., OM4), TE1 mode. The coupling efficiency is −1.97 dB with 1 dB bandwidth of 28 nm.

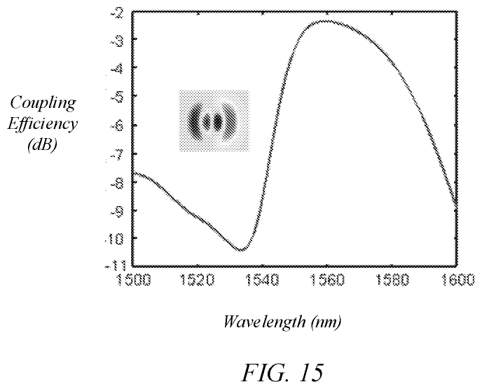

FIG. 15 is a chart of simulated coupling efficiency of an embodiment of an output coupler for orthogonal output coupling into a multimode fiber (e.g., OM4), TE3 mode. The coupling efficiency is −2.35 dB with 1 dB bandwidth of 27 nm.

### V. Example Process

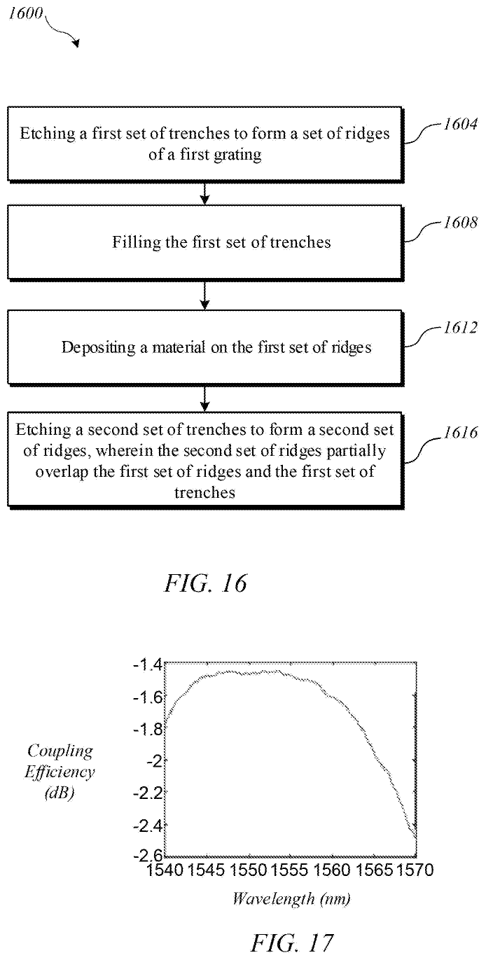

FIG. 16 depicts a flowchart of an embodiment of a process 1600 for fabricating an optical coupler. Process 1600 begins in step 1604 with etching a first set of trenches in a semiconductor layer to form a first set of ridges of a first grating. For example, the first set of trenches 220 to form the first set of ridges 224 of the first grating 104 in FIG. 2. In step 1608, the first set of trenches with an insulating material. For example, the first set of trenches are filled with silicon dioxide. The insulting material has a lower refractive index than the index of the first set of ridges.

In step 1612, a semiconductor material is deposited on both on the first set of ridges and on the insulating material. The semiconductor material has a refractive index to match the first set of ridges. For example, amorphous silicon is deposited and cured to form polycrystalline silicon.

In step 1616, a second set of trenches are etched. The second set of trenches are etched in the semiconductor material to form a second set of ridges of a second grating. For example, the second set of trenches 230 are etched to form the second set of ridges 234 of the second grating 108 in FIG. 2. The second set of ridges partially overlap the first set of ridges and/or partially overlap the insulating material in the first set of trenches. For example, a second ridge 234 partially overlaps a first ridge 224 and partially overlaps a first trench 220 in FIG. 2.

### VI. Experimental Results

FIG. 17 is a chart of experimental orthogonal coupling efficiency of an embodiment of an optical coupler. The optical coupler of FIG. 17 shows high coupling efficiency for vertical (e.g., 90 degrees, plus or minus 1, 3, or 5 degrees from horizontal) output coupling. A two-layer optical coupler can be optimized to give high coupling efficiency for a vertical output grating. The simulation result for a vertical coupled grating is −0.91 dB at 1554 nm and experiment result of a fabricated device is −1.45 dB at 1553 nm. This is 1 dB better than a standard library grating coupler for off-vertical coupling. The simulated high coupling efficiency for off-vertical waveguide grating coupler is −0.72 dB at 1559 nm (3D FDTD simulation).

In some embodiments, the lower layer is used for the TM grating and the upper layer is used for the TE grating. In some embodiments, the lower layer is used for the TE grating and the upper layer is used for the TM grating so that the TE mode grating will have a higher refractive index than the TM mode, which means that the grating period for the TE mode will be smaller than the TM mode grating period. Combining the lower layer for TE and upper layer for TM, the TE mode is mainly diffracted by the lower layer. As for the TM mode, since the lower layer grating period is smaller than the TM grating period, the TM mode can regard the lower layer TE grating as a subwavelength structure, then the TM mode is mainly diffracted by the upper TM grating layer.

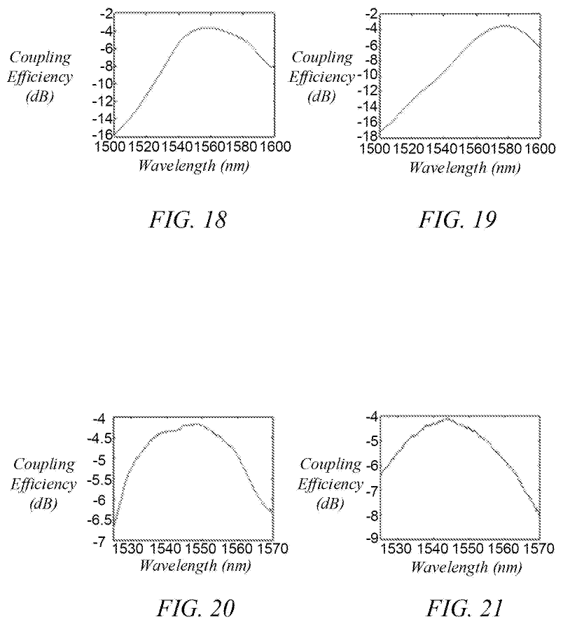

FIGS. 18-22 are graphs of efficiency of an embodiment of a dual-polarization coupler. FIG. 18 is a chart of simulated TE mode coupling efficiency for the dual-polarization coupler. FIG. 19 is a chart of simulated TM mode coupling efficiency for the dual-polarization coupler. FIG. 20 is a chart of experimental TE mode coupling efficiency for the dual-polarization coupler. FIG. 21 is a chart of experimental Tm mode coupling efficiency for the dual-polarization coupler.

In addition to the application of the two-layer waveguide grating coupler for high coupling efficiency for vertical and off-vertical output, the two-layer grating coupler design method can also be used to design dual-polarization grating coupler for TE and TM modes. The dual-polarization coupler is designed by calculating initial periods for a lower grating (e.g., a TE grating) and an upper grating (e.g., a TM grating). An initial period for each grating is calculated by taking a high index value n_H (e.g., vertical structure 3 in FIG. 4), a low index value n_L (e.g., vertical structure 1 in FIG. 4), an initial duty cycle of 0.5, and a calculated effective index in the grating. The lower grating (TE grating) is combined with the upper grating (TM grating). After numerical optimization, the combined gratings form the dual-polarization coupler that is configured to out couple two polarizations of light (in this example the TE fundamental mode and the TM fundamental mode). This procedure was used to design the embodiment of the dual-polarization coupler of FIGS. 18-21. The dual-polarization coupler has a simulation coupling efficiency for TE mode of −3.65 dB at 1558 nm (see FIG. 18) and −3.53 dB at 1578 nm for TM mode (see FIG. 19). The experimental result coupling efficiency for TE mode is −4.175 dB at 1549 nm (see FIG. 20) and −4.11 dB at 1543 nm for TM mode (see FIG. 21).

In one embodiment, the high index region n_H is 380 nm silicon layer (220 nm+160 nm), and the low index region n_L 150 nm silicon (380 nm with etch depth 230 nm). The effective index is calculated in the high index and low index region for the TE and TM mode respectively. The initial period for the TE grating is 543 nm and the initial period for the TM grating is 688 nm. Using a combined structure with the initial periods, simulated coupling efficiency is 18.5% for TE and 17% for TM. After numerical optimization, the dual-polarization coupler produces coupling efficiencies shown in FIGS. 18-21.

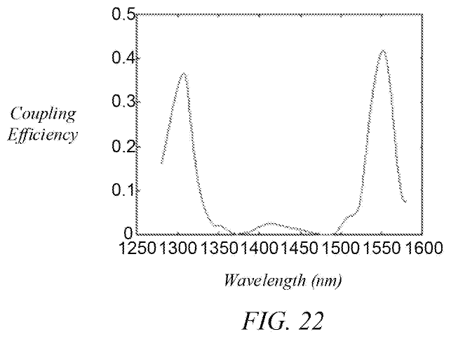

FIG. 22, is a chart of simulated coupling efficiency for an embodiment of a dual-wavelength coupler. The dual-wavelength coupler is an output coupler designed for out coupling light of two different wavelength bands (e.g., λ1 and λ2). Similar to designing the dual-polarization coupler, n_H, n_L an initial duty cycle, and effective refractive index values are used to obtain initial periods for gratings for λ1 and λ2.

The lower grating with an initial period for λ1 and the upper grating with an initial period for λ2 are combined and numerically optimized to form an embodiment of the dual-wavelength coupler. Simulation results for the dual-wavelength coupler for λ1=1310 nm and λ2=1550 nm is 36.5% at 1307 nm and 41.71% at 1550 nm.

As an example, the initial period for 1310 is 443 nm in the lower grating, the initial period for 1550 is 543 nm in the upper grating. Using the combined structure as a starting population to optimize and/or otherwise further improve. Also with a similar analysis as the dual-polarization coupler, using the wavelength with high effective index (smaller period) in the lower layer results in better performance than that with low effective index (larger period) in the lower layer, since the upper layer with large period works for wavelength λ2 can regard the lower layer with small period as a subwavelength structure.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “first”, “second”, “third”, etc. are used to differentiate similar features and not necessarily meant to imply a sequential order.

What is claimed is:

1. A system for optical communication, comprising:
a waveguide having a core of higher refractive index material disposed on a substrate, wherein the core is configured to guide light along a first propagation direction; and
a coupler comprising:
a first grating formed in the higher refractive index material, wherein the first grating comprises a first set of ridges separated by a first set of trenches; and
a second grating, wherein:
the second grating comprises a second set of ridges separated by a second set of trenches;
the first set of ridges is between the substrate and the second set of ridges;
the second set of ridges partially overlap the first set of ridges;
the second set of ridges partially overlap the first set of trenches;
the coupler is configured to couple light out of the waveguide along a second propagation direction; and
the second propagation direction is not parallel with the first propagation direction.

2. The system of claim 1, further comprising an optical fiber positioned to receive light along the second propagation direction.

3. The system of claim 1, wherein the second propagation direction is orthogonal to the first propagation direction.

4. The system of claim 1, wherein the first grating has a non-uniform spacing between ridges.

5. The system of claim 1, wherein the first grating is a blazed grating.

6. The system of claim 1, wherein:
the higher refractive index material is a single-crystal semiconductor;
the second set of ridges comprise a non-single-crystal semiconductor; and
the first set of trenches are filled with material having a lower refractive index than the single-crystal semiconductor material.

7. The system of claim 1, wherein the first set of ridges, the second set of ridges, the first set of trenches, and the second set of trenches each have widths greater than or equal to 170 nm.

8. The system of claim 7, wherein the coupler has a coupling efficiency of better than −2 dB.

9. An optical device comprising:
a substrate;
a first set of ridges;
a second set of ridges, wherein:
the second set of ridges are disposed on the first set of ridges, such that the first set of ridges are between the substrate and the second set of ridges; and
the second set of ridges are offset from the first set of ridges.

10. The optical device of claim 9, wherein the first set of ridges forms a first grating, and the first grating has a non-uniform spacing between ridges.

11. The optical device of claim 10, wherein the non-uniform spacing is characterized by at least one spacing between adjacent ridges having a width that is equal to or greater than 125% of an average value of spacing between adjacent ridges.

12. The optical device of claim 9, wherein:
the first set of ridges are separated by a first set of trenches, as part of a first grating;
the first set of trenches are filled with an insulating material that has a lower refractive index then the first set of ridges;
the second set of ridges are separated by a second set of trenches, as part of a second grating;
the second set of ridges partially overlap the first set of ridges; and
the second set of ridges partially overlap the first set of trenches.

13. The optical device of claim 12, wherein:
the first set of ridges are made in a core of a waveguide;
light is coupled out of the waveguide using the first grating and the second grating;
the first set of ridges and the second set of ridges are configured to cause light from the waveguide to constructively interfere in an upward direction and destructively interfere in a downward direction, thus to enhancing a coupling efficiency of light coupled out of the waveguide; and
the upward direction is a direction from the first grating toward the second grating.

14. A method for fabricating an optical coupler, the method comprising:
etching a first set of trenches in a device layer to form a first set of ridges of a first grating;
filling the first set of trenches with a material having a lower refractive index than the device layer;
depositing an overlay material on the first set of ridges and on the material having a lower refractive index than the device layer; and
etching a second set of trenches in the overlay material to form a second set of ridges of a second grating, wherein the second set of ridges partially overlap the first set of ridges and partially overlap the insulating material in the first set of trenches.

15. The method of claim 14, wherein the overlay material is indexed matched with the device layer.

16. The method of claim 15, wherein the overlay material is amorphous silicon, polysilicon, or dielectric material.

17. The method of claim 14, further comprising implement a numerical method to optimize shift and individual widths of ridges and slits of the first set of ridges and the second set of ridges.

18. The method of claim 17, wherein the numerical method comprises a genetic algorithm or a particle swarm optimization.

19. The method of claim 14, wherein the first set of ridges of the first grating have a non-uniform period.

20. The method of claim 14, the method further comprising etching the device layer to form a waveguide optically coupled with the first grating.
